(19) United States
(12) Patent Application Publication
(10) Pub. No.: US 2012/0166825 A1
(43) Pub. Date: Jun. 28, 2012

(54) Controlling the Power Consumption of Computers

(75) Inventor: Mark Blackburn, Maidenhead (GB)

(73) Assignee: 1E LIMITED, London (GB)

(21) Appl. No.: 13/166,292

(22) Filed: Jun. 22, 2011

(30) Foreign Application Priority Data
Jun. 23, 2010 (GB) 1010543.5

(51) Int. Cl. G06F 1/32

(52) U.S. Cl. 713/310

(57) ABSTRACT

A system comprising a group of computers including a group power controller is provided. Each computer of the group has a performance monitor for monitoring a measure of performance of the computer. The measure of performance is the value of at least one performance metric of the computer excluding contributions to the activity metric(s) of one or more predetermined activities. The group power controller is configured to allocate to the computers of the group shares of a maximum power consumption of the group. The shares are allocated in dependence on the monitored measures of performance. Each computer of the group has an individual power controller configured to limit the power consumption of the computer to the share allocated by the group power controller.

### CROSS-REFERENCE TO RELATED APPLICATIONS

This application claims priority to foreign Patent Application GB 1010543.5, filed on Jun. 23, 2010, the disclosure of which is incorporated herein by reference in its entirety.

### FIELD OF THE INVENTION

The present invention relates to controlling the power consumption of computers.

### BACKGROUND OF THE INVENTION

Computers consume electrical energy to operate. Large server farms having hundreds or even thousands of servers consume very large amount of power. The power consumed by a computer is released as heat and server rooms thus require air conditioning equipment which, in turn, also consumes power. Computers consume electrical energy even when they are apparently idle. An idle computer may consume up to 60% of its fully active power consumption. That is wasteful.

Servers are typically arranged in groups. One group has a common power supply circuit for the group. Power is distributed to the servers of the group from the power supply circuit via a power distribution unit. There may be redundant power supply arrangements for each group. The power supply itself may limit the power available: for example it may have a circuit breaker which limits the maximum available power. If all servers within the group were to demand the maximum power that they were able from the power supply circuit simultaneously, this may trip the circuit breaker and prevent all servers in the group from operating.

One known control server distributes power/energy targets to individual clusters of servers (or power domains). The targets apply to particular time intervals. Each cluster adapts its configuration to meet its target. There is an overall target for all clusters and different targets are allocated to the clusters according to business rules. The allocations may be changed according to the expected loads on the clusters: That is done by the control server on the basis of prior knowledge of variations in load.

One known method controls the allocation of power to a plurality of computers, such as, for example, server blades. A power manager controls the allocation of power to the server blades. The manager controls power control modules of power supplies. A workload manager assigns a power priority to each of a plurality of computers (e.g. each blade) in dependence on application priorities of software assigned for execution on the computers. For example one application program is assigned a higher priority than another. The power priorities are provided to the computers, and power is allocated to the computers according to the assigned priorities.

### SUMMARY OF THE INVENTION

In accordance with one aspect of the present invention, there is provided a system comprising a group of computers including a group power controller, each computer of the group having a performance monitor for monitoring a measure of performance of the computer, wherein the measure of performance is the value of at least one performance metric of the computer excluding contributions to the activity metric(s) of one or more predetermined activities, the group power controller being configured to allocate to the computers of the group shares of a maximum power consumption of the group, the shares being allocated in dependence on the monitored measures of performance, each computer of the group having an individual power controller configured to limit the power consumption of the computer to the share allocated by the group power controller.

Thus the present invention advantageously allows a limited power availability to be shared dynamically amongst computers of a group according to the performance of the computers. The share allocated to a computer, whose performance measure indicates it does not need that share, may be reallocated to other(s) of the computers in the group making more power available to them without exceeding the power limit of the group.

In an embodiment of the invention, if the values of all the performance measures of a computer indicate it is not performing useful work, the computer adopts a preset low power state. That low power state may be the lowest power state in which the computer is able to service requests.

Further features and advantages of the invention will become apparent from the following description of preferred and other embodiments of the invention, given by way of example only, which is made with reference to the accompanying drawings.

### BRIEF DESCRIPTION OF THE DRAWINGS

FIG. 1 is a schematic block diagram of an illustrative network having a server group including a group power controller in accordance with an embodiment of the invention;

FIG. 2 is a schematic flow chart illustrating an example of a process of controlling power of the servers of the group of FIG. 1;

FIG. 3 is a schematic diagram of an example of an individual power controller of a server of the group of FIG. 1;

FIGS. 4A and 4B are a flow chart of an example of a process of allocating power caps to the servers of the group; and

FIG. 5 is a flow chart of an example of a process of measuring performance of a server of the group.

FIG. 6 is a schematic diagram of an operating system and programs present on a server of FIG. 1;

FIG. 7 a schematic diagram of an operating system and programs present on an administrator's workstation of FIG. 1;

FIG. 8 is a schematic diagram of the contents of a database of FIG. 1;

FIG. 9 is a diagram illustrating the calculation of net CPU activity;

FIG. 10 is a diagram illustrating the determining a net number of TCP/IP connections;

FIG. 11 a diagram illustrating the calculation of net I/O activity; and

FIG. 12 is a diagram illustrating the production of a list of excluded activities.

### DETAILED DESCRIPTION

The invention will now be described with reference to the drawing figures, in which like reference numerals refer to like parts throughout.

Overview of Controlling Power of a Group of Servers

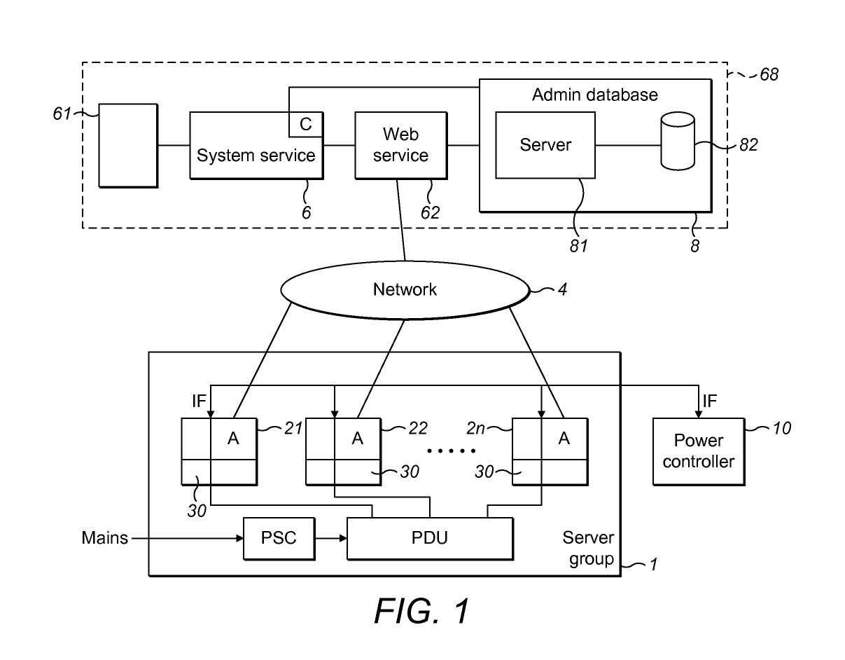

Referring to FIG. 1 a group 1 of servers comprises two or more servers 21, 22 to 2n and a group power controller 10. The group 1 may be one group of a plurality of similar groups connected to the network 4 of FIG. 1. The group power controller may be a server dedicated to group power control or may be one of the servers 21 to 2n. In this example it is a server 10 separate from the servers 21 to 2n and is dedicated to group power control and is not itself subject to power control. The servers 21 to 2n and the power controller 10 have interfaces designated schematically at IF for sending and receiving messages between each server and the power controller.

Power is supplied to the servers 21 to 2n from a power supply circuit PSC connected to the mains. Power is distributed from the PSC to the servers via a power distribution unit PDU. The servers 21 to 2n may have redundant power supply arrangements but FIG. 1 shows only one power supply arrangement for ease of illustration. The embodiments of the present invention described herein do not control the PSC or the PDU and do not measure power consumption at the PSC or PDU.

The group of servers has a total group maximum power consumption Pt allocated to the group. Pt is referred to as the maximum available power hereinafter. The maximum available power Pt is shared amongst the servers 21 to 2n by the group power controller 10. The group power controller receives from the servers 21 to 2n data indicating the performance of the servers and allocates shares of the maximum available power Pt in dependence on the performance data from the servers. Each server receives data representing the share of Pt allocated to it. Each server has an individual power controller 30 which controls the power consumption of the server so that the power consumption of the server does not exceed its allocated share. In other words the allocated share is a limit or cap on the power consumption. That does not mean the server actually consumes power at the limit set by the cap. It may operate at the limit set by the cap, but it may also operate at any power state less than the cap according, for example, to the utilization of the CPU by an application program, or as controlled by the operating system.

The group power controller 10 dynamically reallocates the caps amongst the servers 2n as the performances of the servers vary. In an example of the invention, the measures of performance are measures of “net useful work”, which are produced by performance monitors A of the servers. If a server is not performing net useful work for a preset time, it adopts a predetermined low power state LPS, and its share of the maximum available power Pt is reallocated to the other servers. For example, the difference between the cap allocated to it and the power consumption in its low power state LPS is reallocated to one or more of the other servers by the group power controller 10.

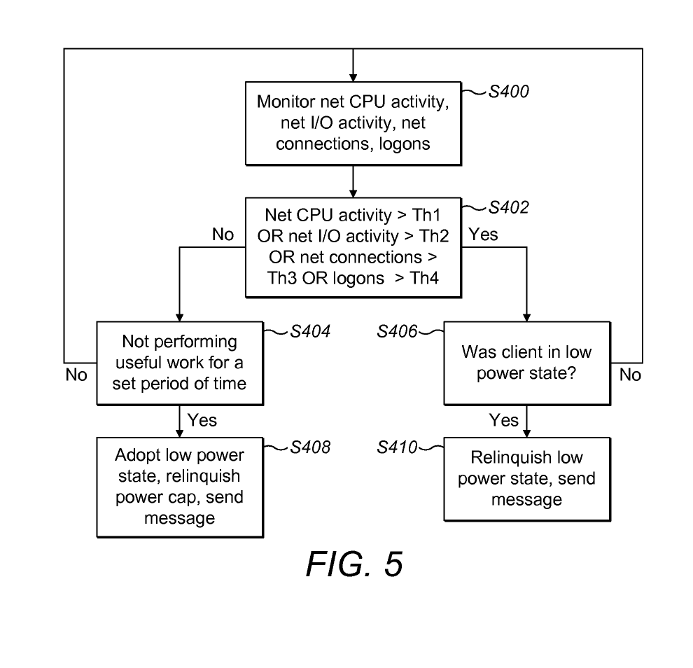

The control of the power consumption of the servers of the group will be described in more detail with reference to FIGS. 1 to 4. The measure of “net useful work” will be described in more detail with reference to FIGS. 5 to 12.

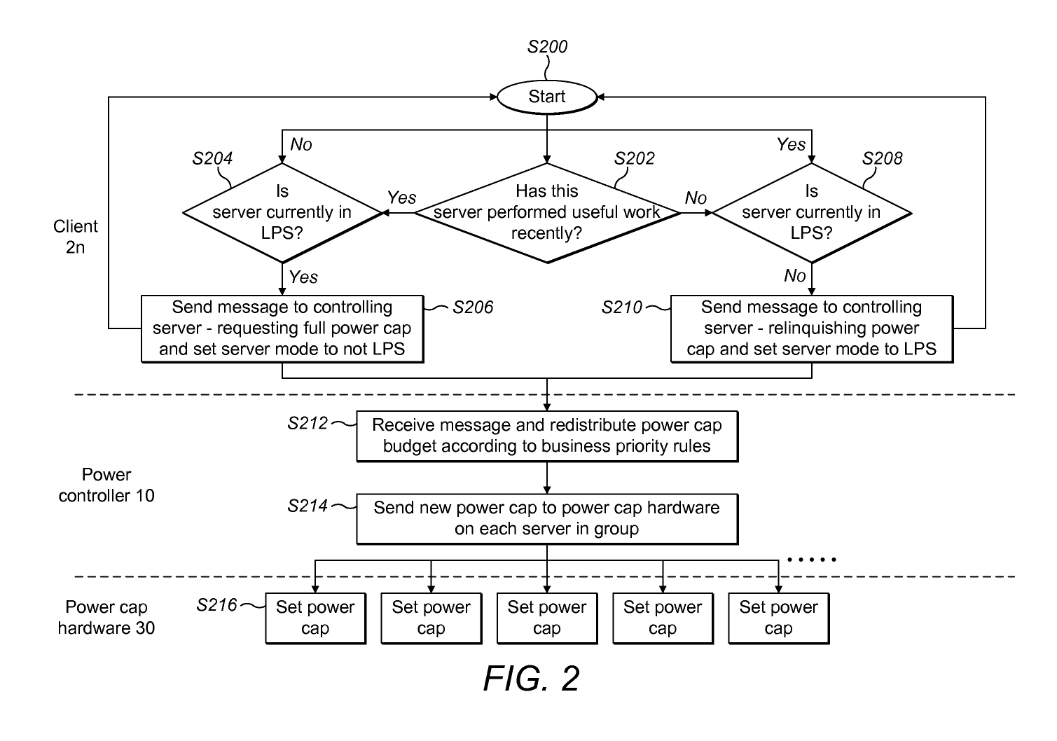

Example of Controlling Power of a Group of Servers (FIGS. 2 to 5)

Referring to FIG. 2, each of the servers 21 to 2n is a client.

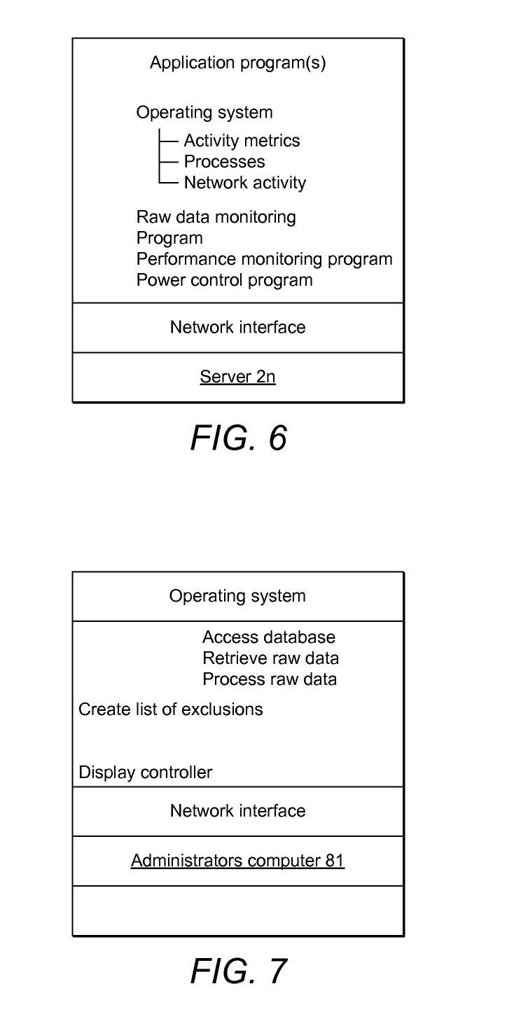

The process of FIG. 2 starts at step S200. At step S202 the process determines whether the client has performed net useful work (as described below with reference to FIG. 5 and to FIGS. 6 to 12). If the answer is YES, than step 204 determines if the client is currently in a predetermined low power state. In this example the predetermined low power state is the lowest power state (LPS) in which the client can service requests f the answer to step S204 is NO, the client is, and has been, active in a higher power state and the process returns to step S202. If the answer to step S204 is YES, it is in the predetermined low power state, and that indicates it now needs to relinquish the predetermined low power state. In step S206, the predetermined low power state is relinquished and a message is sent from the client to the power controller 10 requesting a power cap for the client.

The power controller 10 responds in step S212 to the request of step S206 by recalculating and redistributing the shares of the available maximum power Pt according to business rules which will be described hereinbelow. Because in this case the client has requested a power cap and has relinquished the predetermined low power state, the caps available to the other clients within the overall limit Pt are smaller. Messages containing data defining the new power caps for all the clients are sent to the clients in step S214.

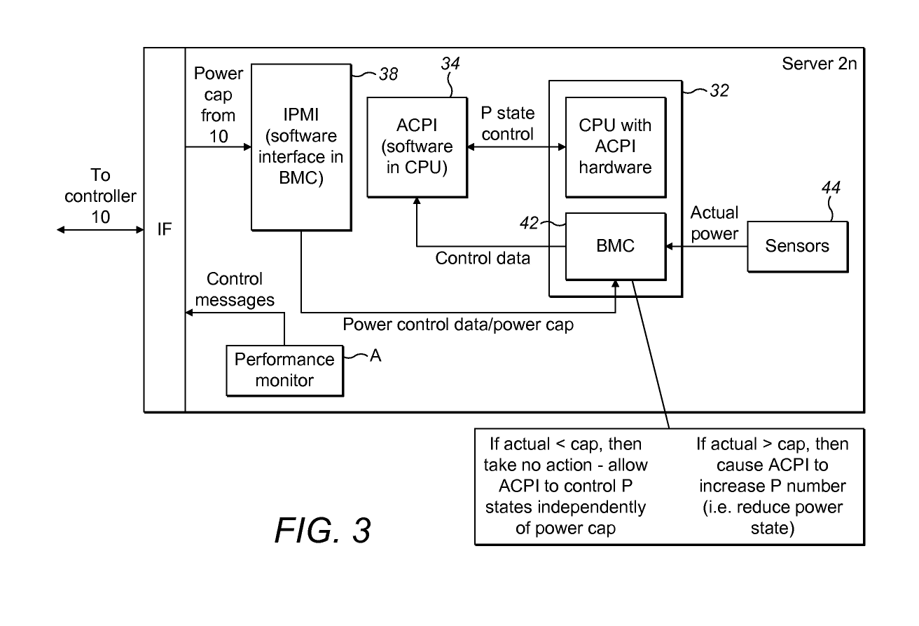

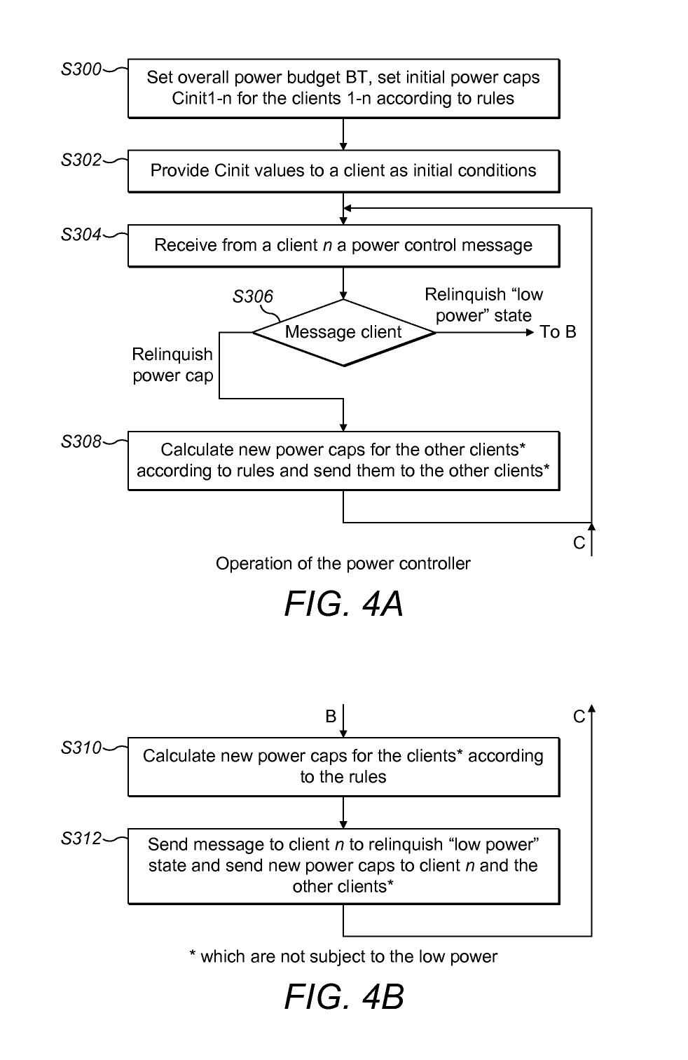

In step S216 the individual power controls 30 in the clients set the power caps in accordance with the power cap data in the messages. Power consumption by the clients is controlled as described by way of example in FIGS. 3 and 4.

Referring back to step S202, if the client has NOT performed useful work, step S208 determines if the client is currently in the predetermined low power state. If the answer to step S208 is YES, the process returns to step S202, because no change is needed in its power state: it has been and continues to be in predetermined low power state. If the answer to step S208 is NO, indicating it has been operating at a higher power within its power cap but now is to adopt the predetermined low power state, in step S210 the client is set to the predetermined low power state and a message is sent from the client to the power controller 10 relinquishing the power cap.

The power controller 10 responds in step S212 to the message provided in step S210 by recalculating and redistributing the shares of the available maximum power Pt according to business rules which will be described hereinbelow. Because in this case the client has relinquished its power cap, larger caps are available for the other clients within the available maximum power Pt. Messages containing data defining the new power caps for all the clients are sent to the clients in step S214.

The foregoing description refers to only one client out of the n clients in the group changing power status. However, more than one client may change power state. Also, none, or any one or more, or all, of the clients may be in the predetermined low power state at the same time.

Example of Power Cap System FIG. 3

A server 2n, representing any server of the group 1, has a motherboard 32 and other components including the interface IF for communicating with the power controller 10. The motherboard 32 has a CPU and control circuitry that implements an ACPI. ACPI is the Advanced Configuration and Power Interface which co-operates in known manner with the Operating System (OS) for power management (and other purposes). The ACPI and OS control the P states of the CPU. The motherboard also has a Baseboard Management Controller (BMC) 42. The server including the motherboard has sensors 44 which provide sensor data to the BMC. The sensor data includes data representing the actual power consumption of the server. The BMC implements an Intelligent Platform Management Interface (IMPI) which is a software interface within the BMC whereby the BMC can receive data from the power controller 10 and from the performance monitor A. The BMC 42 controls the power consumption of the server in accordance with data received from the power controller 10, the performance monitor A and the sensors 44.

Assume the server is performing net useful work and is operating under a power cap represented by data provided by the power controller 10 sent to the BMC via the IMPI. In this example, the BMC controls the power consumption of the server by controlling the P state of the CPU. If the power consumption sensed by the sensors is greater than the cap, the BMC increases the P state (i.e. reduces the power consumption of the CPU). If the power consumption is less than the cap, the BMC allows the ACPI and OS to control the P states independently of the power cap.

If, initially, the server was performing net useful work but the performance monitor A of the server senses that the server is no longer performing net useful work, then in one embodiment as shown in FIG. 3, a control message relinquishing the power cap is sent by the monitor A via the interface IF to the power controller 10. In FIG. 1, each server 2 has direct communication with the power controller 10 via the server's interface IF but the message could be sent to the controller 10 via the IF as a web service post. Any suitable message protocol may be used. The power controller then sends a message to server for forcing it into the low power state and sends one or more other messages to one or more of the other servers reallocating the power caps to the other servers as described above.

In an alternative embodiment, the server which relinquishes the power cap sets itself to the low power state. For that purpose the performance monitor A provides a message or data to the ACPI which sets the low power state and also sends a relinquish power cap message to the power controller 10.

If the performance monitor A detects that the server is resuming net useful work, it sends the “relinquish low power state” message to the power controller 10 which allocates a cap to the server as described above.

Example of Operation of the Power Controller 10 FIGS. 4A and 4B

Referring to FIG. 4A, an example of the power controller 10 operates as follows. The maximum available power Pt is the overall limit on power consumption by the server group 1 of FIG. 1. For initiating operation, the power controller calculates in step S300 initial power caps Cinit1 to n for the clients 21 to 2n in accordance with the business rules. The power caps are then provided in step S302 to the individual power controls 30 of the clients in power control messages.

In step S304 the power controller 10 receives a power control message from one of the clients (as in step S212 of FIG. 2) and in step S306 the message content is read. Assume the message relinquishes the power cap of one of the clients (as in step S210 of FIG. 2). As described above, that client sets itself to the predetermined low power state. In step S308, the power controller calculates new power caps for the other clients (which are not in the low power state) according to the business rules and sends power control messages to the power controls 30 of the clients.

The process then returns to step S304 to await another message.

If in step 304 it receives another message from which step S306 determines that a client, which has been in the low power state, relinquishes that low power state (as in step S206 of FIG. 2), the process proceeds to step S310 of FIG. 4B in which the power controller 10 calculates new power caps for the other clients (which are not in the low power state) according to the business rules and sends power control messages to the power controls 30 of the clients in step S312.

Business Rules

The power caps may be calculated in various ways. For example all the clients which are not in the low power state may have the same power cap.

Alternatively the clients may be allocated different statuses and be allocated different power caps according to their status. For example one client may be dedicated to a particular high priority task or a task which is computationally intensive and so it is allocated a higher cap than other clients.

Variants of the Embodiments of FIGS. 1 to 4

Referring to FIGS. 1 to 4, the embodiments of the invention have been described in which the power controller 10 is not one of the power controlled servers and its power consumption is ignored.

The power controller 30 may be one of the servers 21 to 2n. One of the servers 21 to 2n may be permanently designated as the power controller. Alternatively, the server to act as power controller may be selected dynamically using an election mechanism.

The description of FIGS. 1 to 4 refers to servers but it will be appreciated that the invention is generally applicable to a group of computers.

There may be plural groups of servers. The power controller 10 may be a member of one group 9 in which is does not control power) whilst controlling power in another group.

An overall limit may be applied to the aggregate power consumption of all the groups. The groups may be allocated respective shares of the aggregate power limit.

An Example of Monitoring Performance—“Net Useful Work”—FIGS. 1, 5 and 6 to 12

Illustrative Overview—FIG. 5

Each client 21, 22, 2n of the group has a performance monitor (A in FIG. 1) for monitoring a measure of performance of the computer, wherein the measure of performance is the value of at least one performance metric of the computer excluding contributions to the activity metric(s) of one or more predetermined activities. The measure is a measure of net useful work and an example of how it is produced is described with reference to FIGS. 6 to 12. The excluded activities are activities deemed to be not useful to the dedicated purpose of the client. For example a client may be dedicated to serving users via the network 4. Activities such as virus checking and defragmentation whilst important to the operation of the client do not directly contribute to serving users and are thus deemed to be excluded activities.

In the example of FIG. 5, in step S400, the monitor A monitors net CPU activity, net I/O activity, net connections and logons. Net activity means the measure of activity excluding contributions to the measure of one or more predetermined activities. In step S402 each of those net activity measures is compared with a threshold Th. If all the measures are less than or equal to the thresholds, then at step S404, it is determined whether the client is not performing net useful work for predetermined period of time. If the answer is YES, then at step S408, the client adopts the predetermined low power state and relinquishes the power cap. If the answer is NO, indicating that the absence of useful work occurs for less than the predetermined period of time (implying it has quickly resumed useful work) the process returns to step S400.

If any one or more of the thresholds Th is exceeded in step S402, step S406 then determines whether the client was in the predetermined low power state up to the time of detecting useful work. If the answer is YES, then step S410 relinquishes the low power state and sends a message to the power controller 10 requesting a power cap. If the answer is NO at step S406, (implying the client was already in a higher power state) the process returns to step S400.

FIGS. 6 to 12

Referring to FIG. 1, the system comprises the group 1 of servers 21, 22, 2n, an administrator's workstation 6 with a display device 61, a web service 62 running on a computer, and an administrative database 8 connected by a network 4. The administrator's workstation interacts with the database 8. The web service interacts with the database and the servers 2n. The database may itself comprise a server 81 having a data storage device 82. The database 8 and the workstation 6 together form a monitoring system 68.

In this example of the invention, as illustrated in FIG. 6, each server 2n has, amongst other programs: an operating system; one or more application programs which define the role of the server; a performance monitor, denoted A, which is a monitoring program, in FIG. 1, which monitors activity of the server; and a network interface. The monitoring program interacts with the operating system to obtain the data including information identifying the server and other data, relating to the activities of the computer as described herein below. The monitoring program sends the raw monitored data to the database 8 via the network interface, the network 4 to the web service 62 which transfers the raw data to the database 8. In this example, the monitoring programs A communicate with the web service using the http protocol.

Each server 2n has an individual power controller 30 which controls the power state of the server as described above.

In this example, as indicated in FIG. 7, the administrator's workstation 6 has, amongst other programs, an operating system, a network interface, a display controller, and a program for interfacing with the database.

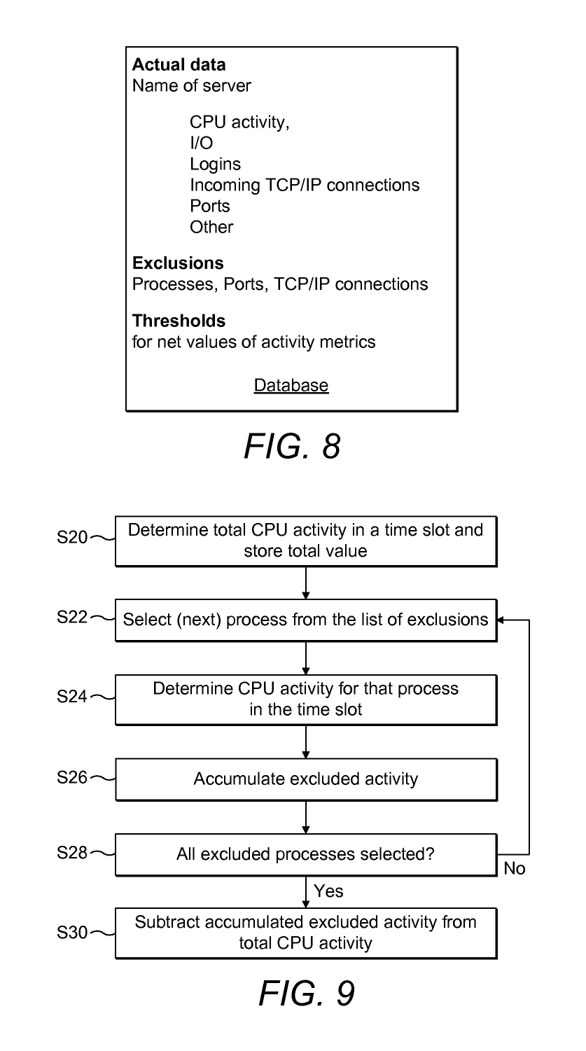

Referring to FIG. 8, the database stores and processes the raw data provided by the monitoring program of a server. In this example the raw data comprises the name of the server, and metrics of CPU activity, I/O, logins, incoming TCP/IP connections, names of processes, identification of incoming TCP/IP connections by a combination of port number used and processes associated with the port and the connection.

The raw data is analysed as discussed below and a data set of excluded processes and a data set of excluded incoming TCP/IP connections identified by a combination of port number and associated process(es) are stored. Also thresholds of activity metrics are stored.

The database may also store the following data which may be used to provide the dataset of excluded activities:—source IP address of incoming TCP/IP connections, data identifying any connection to a process X, any connection to a port Y or any connection from a source IP address Z.

Determine Net Useful CPU Activity: FIG. 9

Net useful CPU activity is measured as shown in FIG. 9. The measurement of net useful activity is based on a data set, which may be a list, of processes, referred to herein as excluded processes, determined in advance to be non-useful activities. (The production of the data set is described below in the section “Creating Data Sets . . . ”).

In step S20, the total value of CPU activity is determined at the time of a time slot t and the total value is stored. The total value includes for example contributions from all processes running on the computer at the time of measurement plus activity attributable to the kernel of the operating system.

In steps S22 to S28, the contributions to the total value from all the excluded processes running at the time of measurement of the total are determined and subtracted from the total value to produce a net value. In this example that is done by selecting a process in step S22 from a list of excluded processes, determining the activity value attributable to that excluded process in step S24, storing the activity value in an accumulator in step S26 and then at steps S28 and S22 selecting the next process and adding its activity value to the value stored in the accumulator in step S26. Once all the processes have been selected the value accumulated in step S26 is subtracted in step S30 from the total stored in step S20 to give the net value.

It will be appreciated that there are other methods of determining net useful CPU activity. For example the activity values of the excluded processes may be subtracted one at a time from the total value of CPU activity instead of accumulating all the activity levels and then subtracting the accumulated values from the total CPU activity value.

The total activity of the CPU as measured in the time slot t and the activity values of the excluded processes are derived from the operating system in known manner using performance counters.

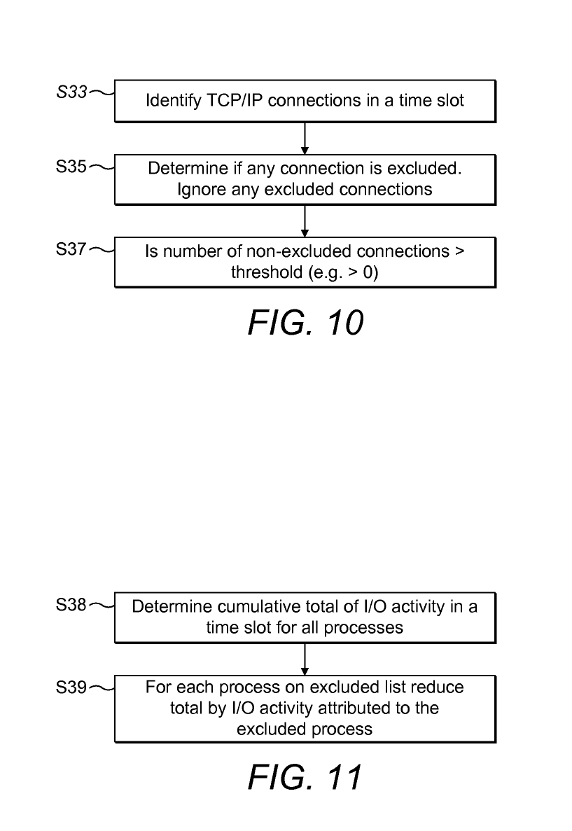

Determine Net Useful TCP/IP Connections: FIG. 10

Net useful connections are determined as shown in FIG. 10. In the time slot t, the incoming TCP/IP connections are identified in step S33. As with CPU activity there is a list of excluded connections. The excluded connections are identified in step S35 and ignored. Step S37 determines if the number of non-excluded incoming connections exceeds a threshold. In this example the threshold is zero, so if there is a single non-excluded incoming TCP/IP connection, that is sufficient to indicate useful activity. Steps S35 and S37 may be achieved by continuously monitoring incoming TCP/IP connections. Any useful connection, i.e. one not on the excluded list, sets a flag; connections on the list are ignored.

The identification of an incoming TCP/IP connection is achieved using port numbers and processes which are provided by instrumentation data provided by the operating system. Information on how to do this is available from Microsoft Corporation for operating systems supplied by them but the invention is not limited to Microsoft's operating systems. The list of excluded incoming TCP/IP connections is list of port numbers and processes associated with those port numbers. The following may also be identified and used in the list: source IP addresses of incoming network connections, and other data for example data identifying any connection to a process X, any connection to a port Y or any connection from a source address Z.

In an alternative implementation, in a time slot t, the total number of all incoming TCP/IP connections is determined, the number of those connections on the excluded list is determined and the number of excluded connections is subtracted from the total number of all incoming TCP/IP connections.

Determine Net Useful I/O Activity: FIG. 11

An example of a measure of I/O activity is the average number of bytes being read and written over the measurement period.

In this example, I/O activity is a single value which is the sum of network I/O, disc I/O and device I/O.

Net useful I/O activity is determined as shown in FIG. 11. In step S38, the total I/O activity is determined at the time of a time slot t and the total value is stored. The total value includes contributions from all processes running on the computer at the time of measurement plus activity attributable to the kernel of the operating system. In step S39, the activity of each excluded process is subtracted from the total activity of step S38 and the net value determined.

Steps S38 and S39 may be implemented as shown in FIG. 9 with I/O activity substituted for CPU activity. The list of excluded processes is the same for both CPU activity and I/O activity in this example, but different lists may be used for CPU activity and I/O activity.

I/O activity associated with the storage of the computer may be monitored separately from network I/O. Also device I/O may be monitored separately. If so, net useful values are determined separately for each type of I/O activity.

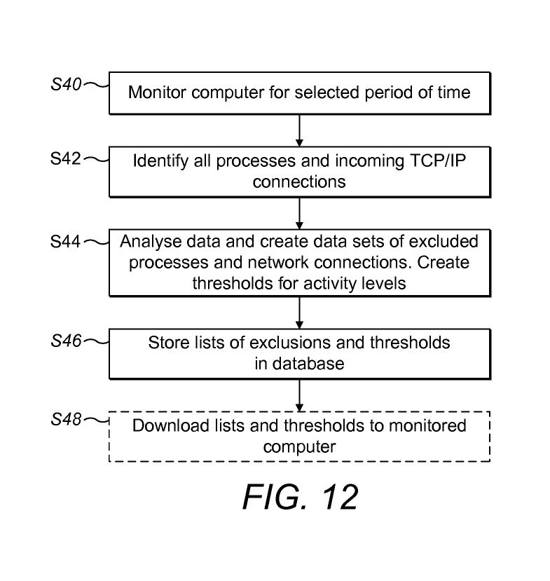

Creating Data Sets of Excluded Processes and Incoming TCP/IP Connections: FIG. 12

As discussed above the embodiments of the invention use data sets of lists of excluded processes and incoming TCP/IP connections. The data sets may be lists. An excluded incoming TCP/IP connection is identified by the combination of a port number and a process.

To produce the datasets in step S40 of FIG. 12, a computer is monitored for a suitable period of time. The time may be a day, a week, a month or any other time deemed to be suitable. The time should be long enough to be confident that all activity of the monitored computer is monitored. The monitoring is done by an agent on the monitored computer which obtains process names and port numbers from the operating system in known manner as discussed above and transmits the combinations of process names and port numbers to the database of FIG. 1. The agent may also obtain other data for example the source address of an incoming TCP/IP connection.

Step S42 identifies all processes run on the computer over the monitoring period, and all incoming network connections of that period. The names of the processes are stored and the combinations of port numbers and process names identifying network connections are stored.

In step S44, a person, for example a network administrator, analyses the stored process names and names of ports and processes identifying network connection. The person creates a first data set of excluded processes and a second data set of excluded network connections identified by the combinations of process names and port numbers. The person uses their judgment to produce the data sets. The person also uses their judgment to set threshold values for the net useful values. In step S46, the data sets and thresholds are stored in the database of FIG. 1.

In step S48, the data sets and the thresholds are downloaded to the monitored computer for use by the agent on the monitored computer which controls the power of the computer.

Variants of the Embodiments of FIGS. 6 to 12

The above embodiments of FIGS. 6 to 12 are to be understood as illustrative examples of the invention. Further variations of FIGS. 6 to 12 are envisaged. For example:

The example described above monitors incoming TCP/IP connections. The invention is not limited to TCP/IP but may be applied to other connection oriented communications protocols. The invention is not limited to monitoring incoming connections: it may monitor outgoing connections in addition to or instead of monitoring incoming connections.

The example described above deems any single log-on to be useful activity. The invention is not limited to a single logon: it may require a minimum number of logons greater than one to signify useful work. An embodiment of the invention may use a data set of one or more excluded logons. For example a logon which is not associated with an external service may be deemed to be non-useful activity. For example, a logon to an account that is used only for maintenance tasks may be considered to be a non-useful activity.

The servers 2n of the network of FIG. 1 may all be controlled in the same way with the same data sets of excluded processes and network connections. However, the servers 2n may be controlled using different data sets of excluded processes and network connections. Each server may be separately monitored to create data sets specific to that server. The data sets specific to a server would be stored in the database with an identifier which associates the data sets with the specific server.

Examples of the invention have been described which involve monitoring a plurality of activities, for example CPU activity, I/O activity, network connections and logons. However, the invention may be implemented monitoring only one activity, for example CPU activity alone; two activities for example CPU activity and I/O activity; or three activities. More than four activities may be monitored. For example a single measure of I/O activity may be replaced by separate measures of network I/O, disc I/O and device I/O.

Whilst the invention has been described by way of example as using programs running on each of the servers 2n to control the servers, the servers may be monitored and controlled remotely.

The embodiments described above sample the total values of one or more activity metrics in each of a succession of time slots. However, an alternative embodiment uses an event monitor instead of time slots and senses the occurrence of an event to initiate sampling of total values and determine the net values.

Computer Programs and Program Carriers

The invention may be implemented by a program or a set of programs which, when run on a computer or set of computers, causes the computer(s) to implement the methods described herein above. In one implementation of the invention:
a program is provided to monitor a server to provide data to the database for the purpose of producing the data sets of excluded activities;
a program A is provided to monitor the performance of the computer: e.g. to determine whether it is performing net useful work;
a program 30 is provided on each server 2n to control the power of the server in dependence on the power capo and the measure of performance;
a program is provided on the power controller to calculate and provide power caps in response to power control messages from the power control programs on the servers; and
a program is provided on the administrators workstation to enable the administrator to analyze the data received from the monitoring programs on the servers to produce the data set of excluded activities.

The programs may be carried by one or more carriers. A carrier may be a signal, a communications channel, a non-transitory medium, or a computer readable medium amongst other examples. A computer readable medium may be: a tape: a disc for example a CD or DVD: a hard disc: an electronic memory; or any other suitable data storage medium. The electronic memory may be a ROM, a RAM, Flash memory or any other suitable electronic memory device whether volatile or non-volatile.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system, comprising:
a group of computers including a group power controller, wherein each computer of the group has a performance monitor for monitoring a measure of performance of the computer, and the measure of performance is the value of at least one performance metric of the computer excluding contributions to the activity metric(s) of one or more predetermined activities,
wherein the group power controller is configured to allocate to the computers of the group shares of a maximum power consumption of the group, the shares being allocated in dependence on the said monitored measures of performance, and
wherein each computer of the group has an individual power controller configured to limit the power consumption of the computer to the share allocated by the group power controller.

2. The system according to claim 1, wherein the power controller comprises a computer additional to said computers having performance monitors and individual power controllers.

3. The system according to claim 1, wherein the power controller comprises one of the computers having performance monitors and individual power controllers.

4. The system according to claim 1, wherein any of the computers of the group having a performance monitor is configured to adopt a predetermined low power state if the measure of performance is less than a threshold value, the group power controller being responsive to the adoption of the state to reallocate the shares of the group maximum power consumption to the others of the computers which are not in the state.

5. The system according to claim 4, wherein each of the computers of the group having a performance monitor is configured to adopt the predetermined low power state if the measure of performance is less than a threshold value for a predetermined period of time.

6. The system according to claim 1, wherein the group power controller is configured to allocate the shares to the computers according to preset rules.

7. The system according to claim 6, wherein the computers are allocated different statuses and the group power controller is configured to allocate the shares according to the statuses of the computers.

8. A computer-implemented method of controlling the power consumption of a group of computers including a group power controller, the method comprising:
monitoring a measure of performance of each computer of the group, wherein the measure of performance is the value of at least one performance metric of the computer excluding contributions to the activity metric(s) of one or more predetermined activities;
allocating to the computers of the group shares of a maximum power consumption of the group, the shares being allocated by the group power controller in dependence on the monitored measures of performance; and
limiting the power consumption of each computer to the share allocated by the group power controller.

9. A non-transitory computer readable medium, or a set of non-transitory computer readable media, having instructions stored thereon for execution by a group of computers, the instructions configuring the computers of the group to:
monitor a measure of performance of each computer of the group, wherein the measure of performance is the value of at least one performance metric of the computer excluding contributions to the activity metric(s) of one or more predetermined activities;
allocate to the computers of the group shares of a maximum power consumption of the group, the shares being allocated by the group power controller in dependence on the monitored measures of performance; and
limit the power consumption of each computer to the share allocated by the group power controller.

10. A computer for use in the system according to claim 1, the computer including:
a performance monitor for monitoring a measure of performance of the computer, wherein the measure of performance is the value of at least one performance metric of the computer excluding contributions to the activity metric(s) of one or more predetermined activities;
an interface for receiving, from a group power controller, data representing a share of the maximum power consumption of the group; and
an individual power controller configured to limit the power consumption of the computer to the share allocated to the computer.

11. A non-transitory computer readable medium, having instructions stored thereon for execution by a computer of a group of computers, the instructions configuring the computer to:
monitor a measure of performance of the computer, wherein the measure of performance is the value of at least one performance metric of the computer excluding contributions to the activity metric(s) of one or more predetermined activities;
receive, from a group power controller, data representing a share of the maximum power consumption of the group; and
limit the power consumption of the computer to the share allocated to the computer.

12. A group power control computer for use in the system according to claim 1, the power control computer including an interface for receiving from other computers of the group data representing monitored measures of performance of the other computers of the group, the power control computer being configured to allocate, to the other computers of the group, shares of a maximum power consumption of the group, the shares being allocated in dependence on the said received measures of performance.

13. A non-transitory computer readable medium, having instructions stored thereon for execution by a power control computer for use in a group of computers, the instructions configuring the computer to:
receive from other computers of the group data representing monitored measures of performance of the other computers of the group; and
allocate, to the other computers of the group, shares of a maximum power consumption of the group, the shares being allocated in dependence on the received measures of performance.
